(19) United States
(12) Patent Application Publication
(10) Pub. No.: US 2013/0318250 A1
(43) Pub. Date: Nov. 28, 2013

(54) METHOD FOR CONNECTING BETWEEN TERMINALS

(71) Applicant: RSupport Co., Ltd., Seoul (KR)

(72) Inventor: Hyung Su Seo, Gyeonggi-do (KR)

(73) Assignee: RSUPPORT CO., LTD., Seoul (KR)

(21) Appl. No.: 13/899,434

(22) Filed: May 21, 2013

(30) Foreign Application Priority Data
May 21, 2012 (KR) 10-2012-0053384

(51) Int. Cl. H04L 29/06

(52) U.S. Cl. CPC H04L 65/1069
USPC 709/228

(57) ABSTRACT

Disclosed is a terminal connection method. The method includes providing an identifier and network state information of a first terminal to a server; and upon a request of a second terminal, establishing a network with the second terminal on the basis of the network state information. It is possible to connect terminals with each other over a network by simply entering a registered ID when the terminals are connected over the network, thereby quickly and easily connect the terminals.

### CLAIM FOR PRIORITY

This application claims priority to Korean Patent Application No. 10-2012-0053384 filed on May 21, 2012 in the Korean Intellectual Property Office (KIPO), the entire contents of which are hereby incorporated by reference.

### BACKGROUND OF INVENTION

1. Technical Field

Example embodiments of the present invention relate in general to a terminal connection method and more specifically to a terminal connection method for connecting terminals with each other over a network.

2. Related Art

In general, when terminals are connected over a network (for example, 3G, 4G, WiFi, WiBro, Bluetooth, etc.), the addresses (for example, Internet protocol (IP) address, port, etc.) of the terminals should be known. For example, when a user connects a smartphone to a computer, the user may find out the IP address allocated to the computer and set a network on the basis of the IP address allocated to the computer (that is, the user directly enters the IP address of the computer into a terminal connection application installed in the smartphone) to connect the smartphone to the computer.

Similarly, when a user connects a computer to a smartphone, the user may find out the IP address allocated to the smartphone and set a network on the basis of the IP address allocated to the smartphone (that is, the user directly enters the IP address of the smartphone into the terminal connection application installed in the computer) to connect the computer to the smartphone.

In order to connect terminals over a network, a user should check an IP address of each terminal and directly enter the IP address of the terminal into the terminal connection application. Thus, it takes considerable time and effort to connect the terminals with each other.

In particular, in order to maintain a network connection between terminals in an environment where an IP address is dynamically allocated to a terminal, a user should continuously check the IP address dynamically allocated, and if the allocated IP address is changed, should reset the network on the basis of the changed IP address. Thus, it takes much more time and effort to maintain the connection between the terminals in the environment where the IP address is dynamically allocated

### SUMMARY OF INVENTION

Accordingly, example embodiments of the present invention are provided to substantially obviate one or more problems due to limitations and disadvantages of the related art.

Example embodiments of the present invention provide a terminal connection method capable of connecting terminals over a network.

In some example embodiments, a terminal connection method performed by a first terminal includes providing an identifier and network state information of the first terminal to a server, and upon a request of a second terminal, establishing a network with the second terminal on the basis of the network state information.

The terminal connection method may further include storing a password in the first terminal before or after any one of the operations described above is performed.

The terminal connection method may further include, when the network state information is changed after providing the identifier and network state information to the server, providing the changed network state information to the server.

The providing of the identifier and the network state information to the server may include providing as the network state information at least one of an IP address, a subnet mask address, a gateway address, an application port, and connectable connection means to the server.

The establishing of a network with the second terminal may include receiving a password from the second terminal, determining whether the password received from the second terminal is the same as the stored password, and if the password received from the second terminal is the same as the stored password, establishing the network with the second terminal.

In other example embodiments, a terminal connection method performed by a first terminal includes providing an identification of the first terminal to a server, providing network state information of the first terminal to the server, and upon a request of a second terminal, establishing a network with the second terminal on the basis of the network state information.

In still other example embodiments, a terminal connection method performed by a second terminal includes providing an identifier of a first terminal to a server, receiving network state information of the first terminal corresponding to the identifier from the server, and establishing a network with the first terminal on the basis of the network state information.

The establishing of a network with the first terminal may include providing a password corresponding to the identifier to the first terminal, and establishing the network with the first terminal on the basis of the network state information according to an approval response to the provision of the password.

In yet other example embodiments, a terminal connection method performed by a server includes receiving an identifier and network state information of a first terminal, registering the identifier and the network state information, and upon a request of a second terminal, providing the network state information to the second terminal.

The terminal connection method performed by a server may further include receiving changed network state information of the first terminal after registering the identifier and network state information, and upon a request of the second terminal, providing the changed network state information to the second terminal.

The receiving of the identifier and the network state information may include receiving as the network state information at least one of an IP address, a subnet mask address, a gateway address, an application port, and connectable connection means.

The registering of the identifier and the network state information may include registering the identifier and the network state information such that the network state information is mapped into the identifier.

In yet other example embodiments, a terminal connection method performed by a server includes receiving an identifier of a first terminal, receiving network state information of the first terminal, registering the identifier and the network state information, and upon a request of a second terminal, providing the network state information to the second terminal.

### BRIEF DESCRIPTION OF DRAWINGS

Example embodiments of the present invention will become more apparent by describing in detail example embodiments of the present invention with reference to the accompanying drawings, in which:

FIG. 1 is a block diagram showing a terminal connection apparatus according to an embodiment of the present invention;

FIG. 2 is a flowchart showing a terminal connection method according to an embodiment of the present invention;

FIG. 3 is a flowchart showing another terminal connection method according to an embodiment of the present invention;

FIG. 4 is an initial interface screen of a host terminal;

FIG. 5 is an interface screen of a host terminal for setting an identifier;

FIG. 6 is an interface screen of a host terminal for setting a password;

FIG. 7 is an interface screen of a host terminal for checking network connection standby information;

FIG. 8 is an interface screen of a host terminal for registering a client terminal;

FIG. 9 is an interface screen of a host terminal for changing a password;

FIG. 10 is an interface screen of a host terminal for checking network connection information;

FIG. 11 is another interface screen of a host terminal for checking network connection information;

FIG. 12 is yet another interface screen of a host terminal for checking network connection information;

FIG. 13 is an initial interface screen of a client terminal; and

FIG. 14 is an interface screen of a client terminal for entering a password.

### DESCRIPTION OF EXAMPLE EMBODIMENTS

Example embodiments of the present invention are disclosed herein. However, specific structural and functional details disclosed herein are merely representative for purposes of describing example embodiments of the present invention, and thus example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in reverse order, depending upon the functionality/acts involved.

Embodiments of the present invention will be described below in more detail with reference to the accompanying drawings. In describing the invention, to facilitate the entire understanding of the invention, like numbers refer to like elements throughout the description of the figures, and a repetitive description on the same element is not provided.

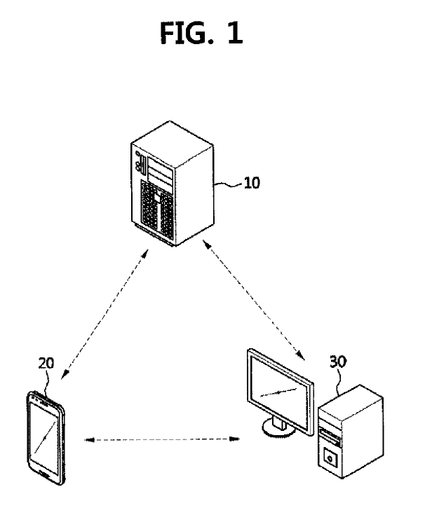

FIG. 1 is a block diagram showing a terminal connection apparatus according to an embodiment of the present invention.

Referring to FIG. 1, a host terminal 20 and a client terminal 30 may be connected via an authentication server 10. The authentication server 10 may be a server for relaying the connection between the host terminal 20 and the client terminal 30. The host terminal 20 may be considered to be a terminal for receiving a connection request, and the client terminal 30 may be considered to be a terminal for transmitting a connection request. Here, the host terminal 20 and the client terminal 30 may be the same type of terminals (for example, smartphone-smartphone) or different types of terminals (for example, smartphone-computer).

The connection between the authentication server 10 and the host terminal 20, the connection between the authentication server 10 and the client terminal 30, and the connection between the host terminal 20 and the client terminal 30 may be established via a wired or wireless network.

Here, the terminal may include a communication-enabled desktop computer, laptop computer, tablet PC, wireless phone, mobile phone, smartphone, e-book reader, portable multimedia player (PMP), portable gaming console, navigation device, digital camera, digital multimedia broadcasting (DMB) player, digital audio recorder, digital audio player, digital picture recorder, digital picture player, digital video recorder, digital video player, etc.

Here, the network may include Bluetooth, infrared communication, a 2G mobile communication network such as Global System for Mobile communication (GSM) and Code Division Multiple Access (CDMA), wireless Internet such as Wireless Fidelity (WiFi) or WiFi direct, portable Internet such as Wireless Broadband Internet (WiBro) or World Interoperability for Microwave Access (WiMax), or a mobile communication network for supporting packet transmission (for example, a 3G mobile communication network such as Wideband Code Division Multiple Access (WCDMA) or CDMA2000, a 3.5G mobile communication network such as High Speed Downlink Packet Access (HSDPA) or High Speed Uplink Packet Access (HSUPA), and a 4G mobile communication network such as a Long Term Evolution (LTE) network or LTE-Advanced network.

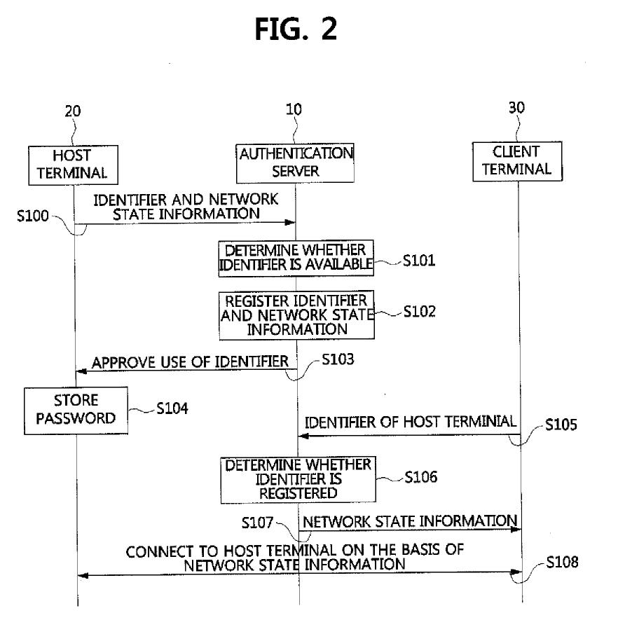

FIG. 2 is a flowchart showing a terminal connection method according to an embodiment of the present invention.

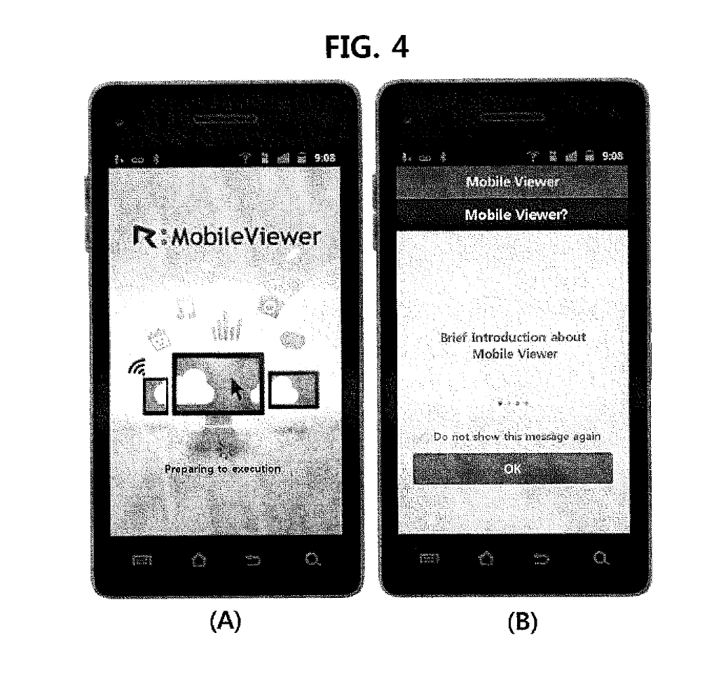

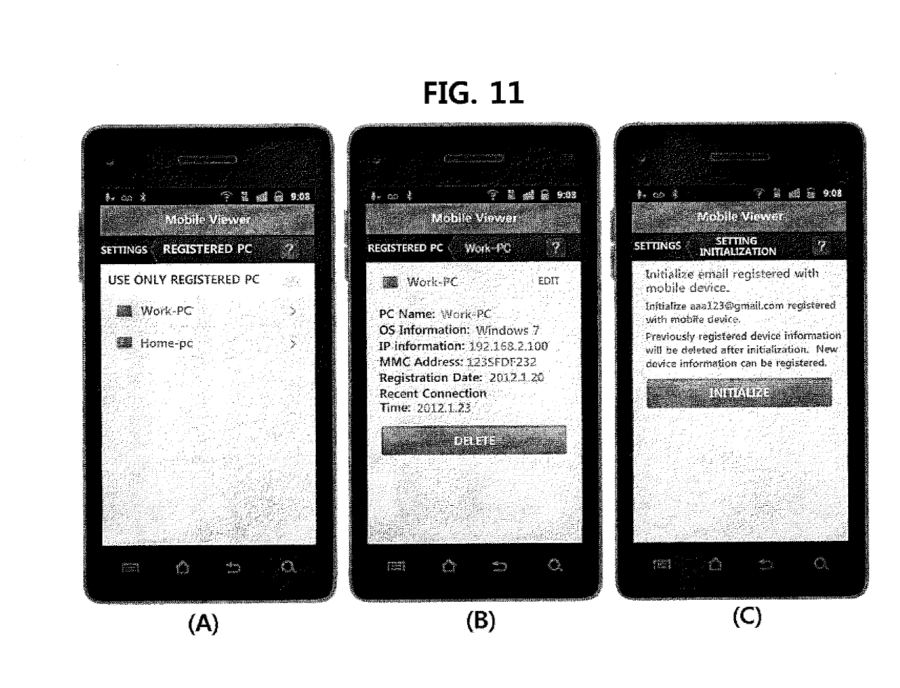

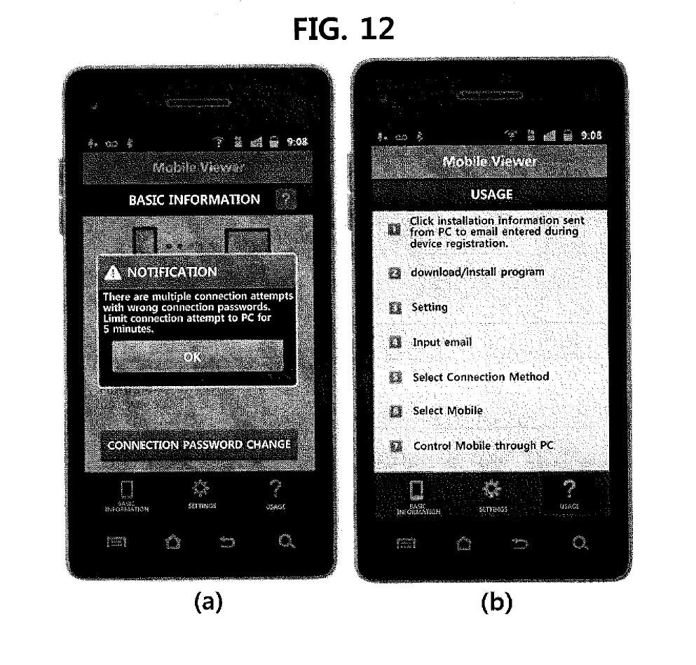

Referring to FIG. 2, a method of establishing a network between the host terminal 20 and the client terminal 30 using the authentication server 10 will be described in detail. Furthermore, referring to FIGS. 4 to 14, it will be described in detail how a terminal connection method according to an embodiment of the present invention is performed on the interface of the terminal.

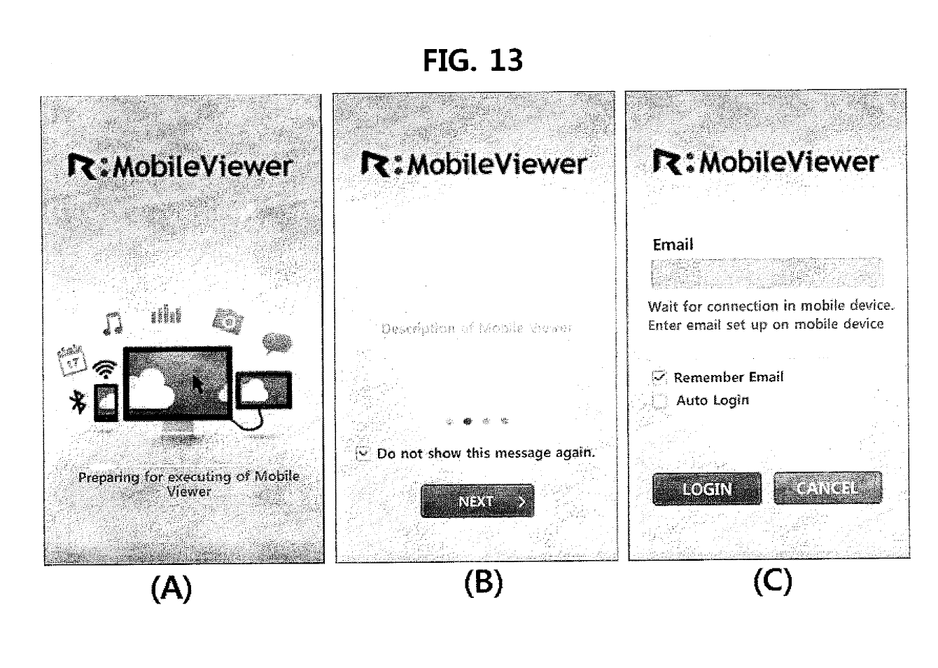

The terminal connection method performed by the host terminal 20 may be executed on the terminal connection application installed in the host terminal 20. The host terminal 20 may display the initial interface screen of the application as shown in FIGS. 4(a) and 4(b). The terminal connection method performed by the client terminal 30 may be executed on the terminal connection application installed in the client terminal 30. The client terminal 30 may display the initial interface screen of the application as shown in FIGS. 13(a) and 13(b).

The host terminal 20 may receive, from a user, an ID for identification of itself from another terminal and use the received ID as an identifier. In this case, an e-mail address, an international mobile equipment identity (IMEI), etc. may be used as the identifier.

Also, the host terminal 20 may provide at least one available ID to a user through a display device, and use, as the identifier, an ID selected by the user from among available IDs provided through the display device. Here, the available ID may include an ID previously stored by the user in the host terminal.

The host terminal 20 may provide the above-described identifier and network state information to the authentication server 10 (S100). Here, the network state information may include at least one of an IP address (for example, IPv4, IPv6, etc.), a subnet mask address, a gateway address, an application port, and connectable-network information of the host terminal 20. The connectable-network information denotes information about a network currently connected by the host terminal 20. For example, the connectable-network information includes ‘WiFi’ when the host terminal 20 is connected to a WiFi network, includes ‘4G’ when the host terminal 20 is connected to a 4G network, and includes ‘USB’ when the host terminal 20 is connected using a USB.

The authentication server 10 may receive the identifier and network state information and then determine whether the received identifier is available (S101). In this case, if the identifier received from the host terminal 20 is not available (for example, if the identifier received from the host terminal 20 has been already used as an identifier of another terminal), the authentication server 10 may request the host terminal 20 to provide a new identifier.

If the identifier received from the host terminal 20 is available (for example, if the identifier received from the host terminal 20 is not used as an identifier of another terminal), the authentication server 10 may register the identifier and network state information with its own database (S102). In this case, the authentication server 10 may register the network state information with the database in order to map the network state information into the identifier of the host terminal 20.

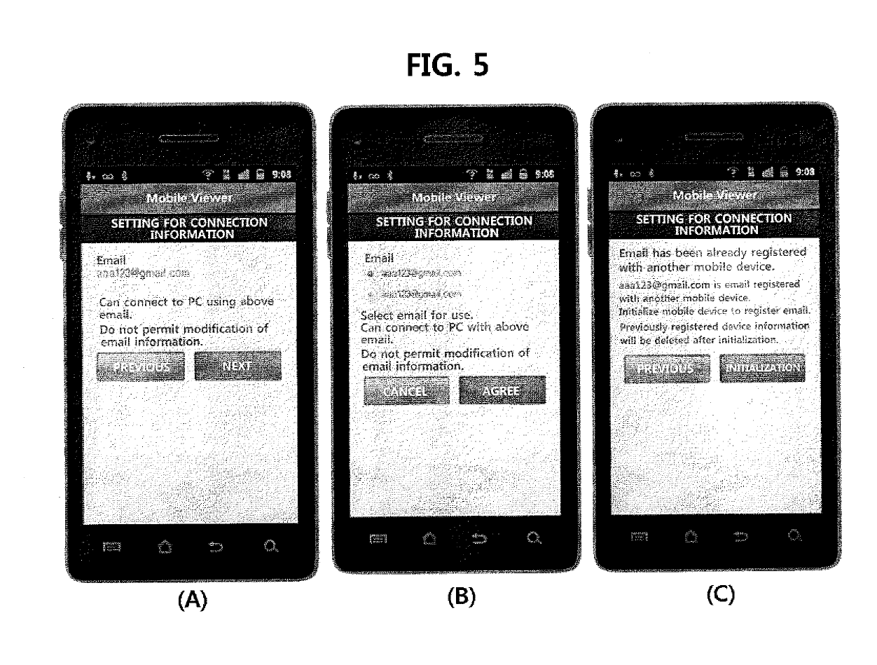

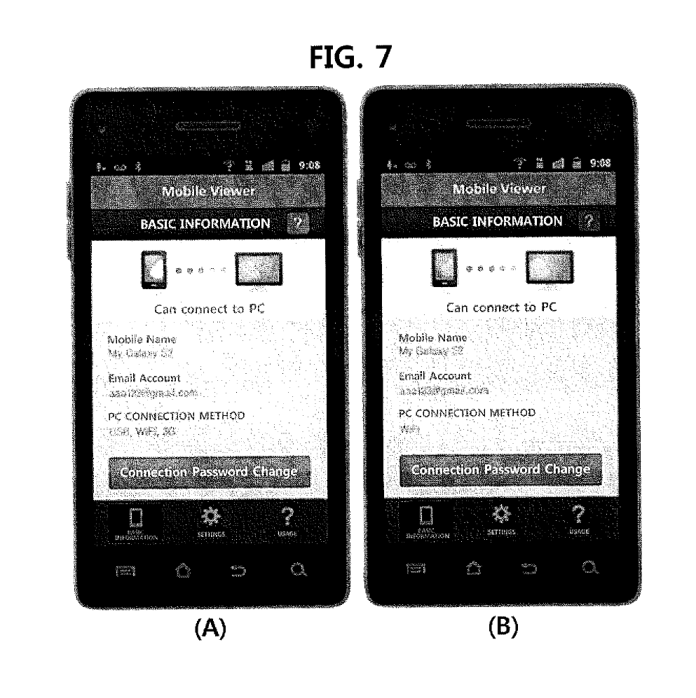

Here, the host terminal 20 may display an interface screen for operations S100 and S101 as shown in FIGS. 5(a), 5(b), and 5(c), and display the connection standby interface screen as shown in FIGS. 7(a) and 7(b) when the identifier and network state information of the host terminal 20 are registered with the authentication server 10.

After the identifier and network state information are registered, the authentication server 10 may give approval for the use of the identifier to the host terminal 20 (S103). In FIG. 2, operation S103 is shown to be performed after operation S102. However, operation S103 may be performed before operation S102.

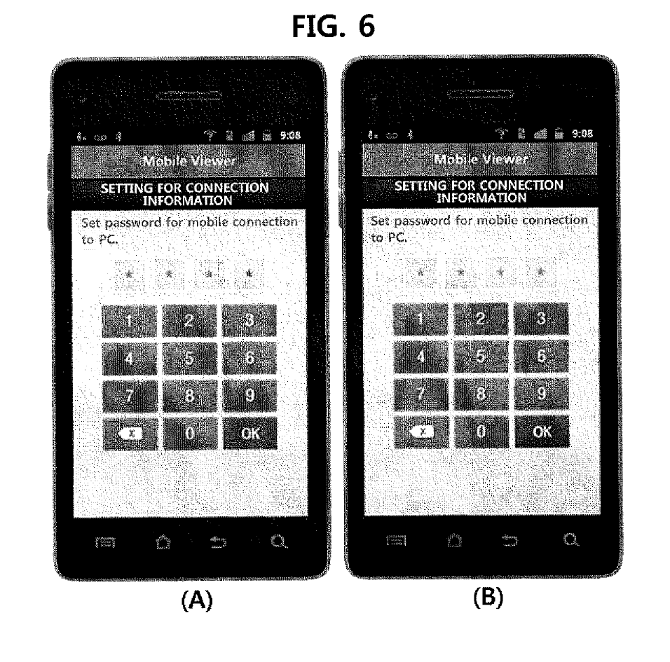

After the identifier is approved, the host terminal 20 may store a password corresponding to the approved identifier in its own database (S104). That is, the host terminal 20 may receive the password corresponding to the identifier from the user and store the received password. In this case, a combination of Hangul (Korean alphabet), alphabet, number, symbol, etc. may be used as the password, and the password may be encrypted and stored. Here, the host terminal 20 may display an interface screen for operation S 104, as shown in FIGS. 6(a) and 6(b). In this way, the host terminal 20 can store the password for network connection in its own database, thereby preventing the password from leaking out and thus further enhancing security.

In FIG. 2, operation S104 is shown to be performed after operation S103. However, operation S104 may be performed before any of operations S100, S101, S102, and S103.

Alternatively, an embodiment of the present invention may be performed without operation S104.

After the authentication server 10 registers the identifier and network state information, the client terminal 30 may receive the identifier of the host terminal 20 from the user and provide the received identifier of the host terminal 20 to the authentication server 10 (S105). Here, the client terminal 30 providing the identifier of the host terminal 20 to the authentication server 10 may be considered as requesting the provision of the network state information mapped into the identifier. The client terminal 30 may display an interface screen for operation S105, as shown in FIG. 13(c).

When the authentication server 10 receives the identifier of the host terminal 20 from the client terminal 30, the authentication server 10 may determine whether the received identifier is the identifier registered with the database (S106). If the identifier received from the host terminal 20 is determined to be the identifier registered with the database, the authentication server 10 may provide the network state information mapped into the received identifier to the client terminal 30 (S107). If the identifier received from the host terminal 20 is determined not to be the identifier registered with the database, the authentication server 10 may request the client terminal 30 to provide another identifier or complete a network establishment process.

When the client terminal 30 receives the network state information, the client terminal 30 may establish a network with the host terminal 20 on the basis of the network state information in order to be connected to the host terminal 20 (S108).

In operation S108, the client terminal 30 may receive a password from the user and provide the received password to the host terminal 20 on the basis of the network state information. After the host terminal 20 receives the password from the client terminal 30, the host terminal may determine whether the received password is the same as the password stored in operation S104. If the received password is the same as the password stored in operation S104, the host terminal 20 may approve the network connection, and the client terminal 30 may establish a network with the host terminal 20 according to the approval of the network connection. If the received password is different from the password stored in operation S104, the host terminal 20 may request the client terminal 30 to provide another password or complete the network establishment process.

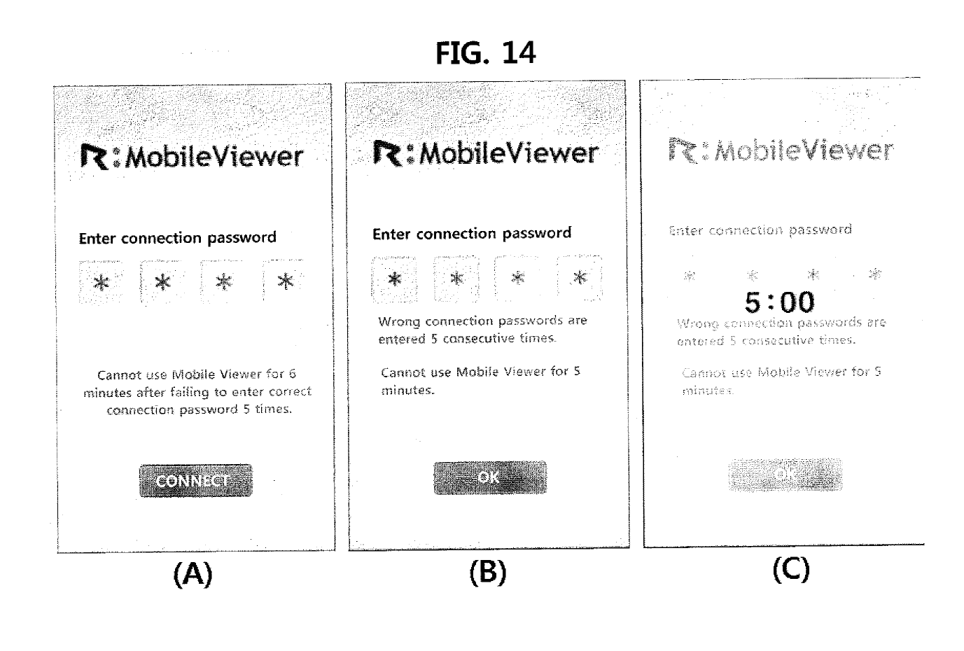

Here, the client terminal 30 may display an interface screen for entering the password as shown in FIG. 14(a) and may display an interface screen as shown in FIGS. 14(b) and 14(c) when the entered password is different from the password stored in operation S104.

Here, it can be omitted that the host terminal 20 approves the network connection with the client terminal 30 depending on whether the passwords are the same.

The process of establishing a network between the client terminal 30 and the host terminal 20 will be described in detail below. If the network state information received by the client terminal 30 includes ‘IP 192.10.10.10,’ ‘application port 9000,’ ‘connectable-network information WiFi,’ the client terminal 30 may set the network, IP address, and application port as ‘WiFi,’ ‘192.10.10.10,’ and ‘9000,’ respectively, and then try to connect to the host terminal 20.

Furthermore, if the network state information received by the client terminal 30 includes information about a plurality of connectable network, the client terminal 30 may try to connect to the host terminal 20 on the basis of information about a connectable network requested by the user. For example, if the connectable network includes ‘4G’ and ‘USB,’ the client terminal 30 may try to connect to the host terminal 20 through a ‘4G’ network or ‘USB’ upon the user's request.

Furthermore, if the network state information received by the client terminal 30 includes information about a plurality of connectable network, the client terminal 30 may try to connect to the host terminal 20 on the basis of the connectable-network information according to predetermined priorities. For example, if the connectable network includes ‘4G’ and ‘USB’ and ‘4G’ is set to have a priority higher than ‘USB’, the client terminal 30 may try to connect to the host terminal 20 through a ‘4G’ network. The client terminal 30 may try to connect to the host terminal 20 through ‘USB’ only when the client terminal 30 fails to connect to the host terminal 20 through the ‘4G’ network.

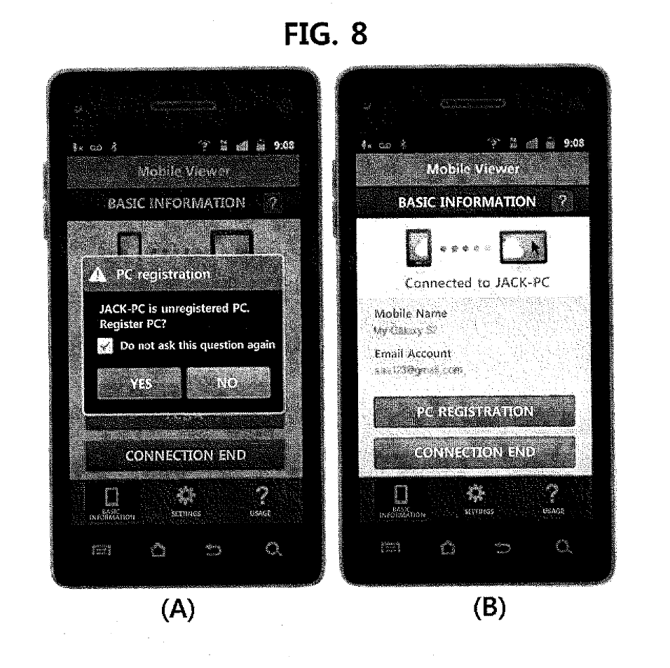

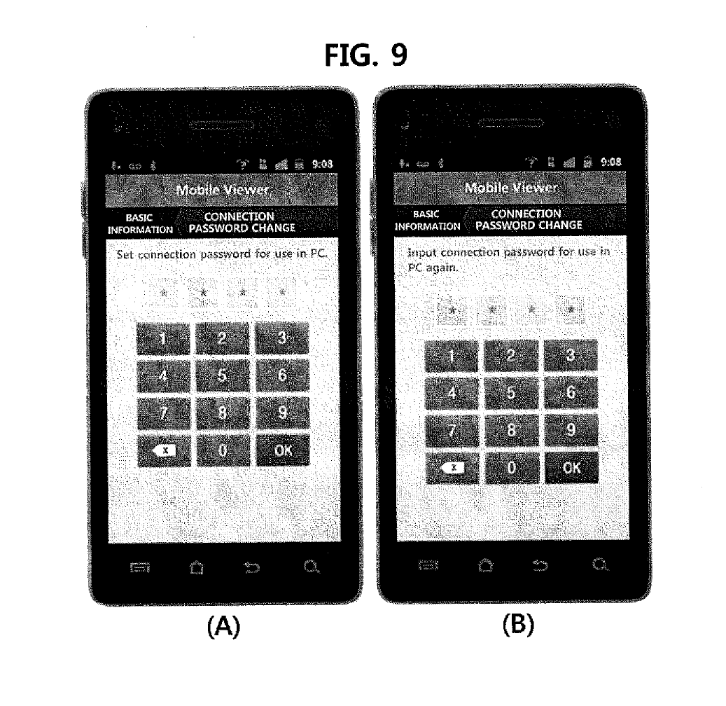

When a network between the host terminal 20 and the client terminal 30 is established using the above-described method, the host terminal 20 may display an interface screen for registering the client terminal 30 as shown in FIGS. 8(a) and 8(b). The password stored in operation S104 may be changed as shown in FIGS. 9(a) and 9(b).

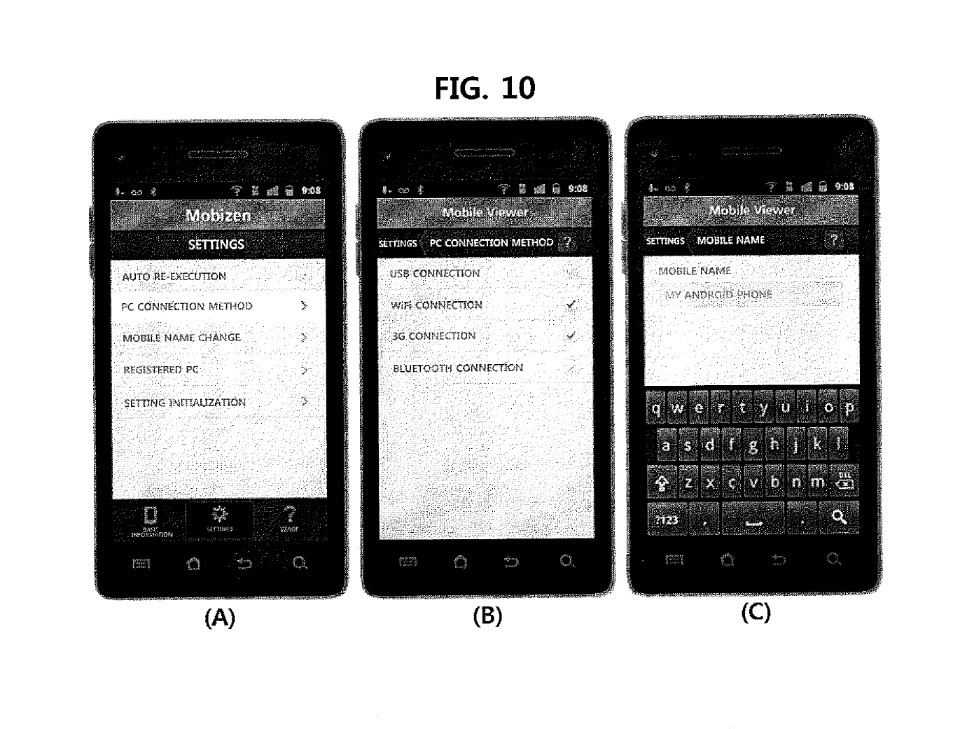

Also, in the interface screen of the host terminal 20, the connection state (for example, the method for connecting to the client terminal 30, the name of the host terminal 20, the registered client terminal 30, etc.) between the host terminal 20 and the client terminal 30 may be checked and changed as shown in FIGS. 10 to 12.

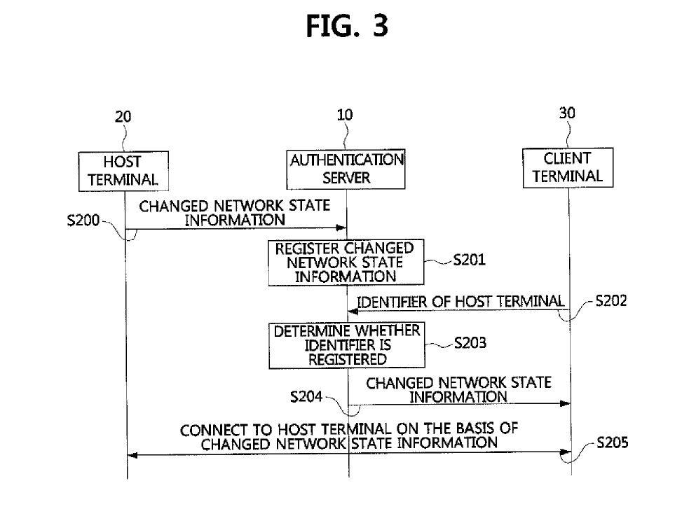

FIG. 3 is a flowchart showing another terminal connection method according to an embodiment of the present invention.

Referring to FIG. 3, a method for establishing a network between the host terminal 20 and the client terminal 30 when the network state information of the host terminal 20 is changed will be described in detail below.

If the network state information of the host terminal 20 is changed (for example, the connectable-network information changes from ‘WiFi’ to ‘4G’) after the authentication server 10 registers the network state information with the database, the host terminal 20 may provide the changed network state information to the authentication server 10 (S200). In this case, the host terminal 20 may provide its identifier in addition to the changed network state information, to the authentication server 10. Here, the changed network state information may include at least one of an changed IP address (for example, IPv4, IPv6, etc.), a changed subnet mask address, a changed gateway address, a changed application port, and changed connectable-network information of the host terminal 20.

When the authentication server 10 receives the changed network state information from the host terminal 20, the authentication server 10 may register the changed network state information with the database (S201). That is, the authentication server 10 may retrieve the received identifier in addition to the changed network state information in the database and change the network state information, which is mapped into the retrieved identifier, into the changed network state information.

After the changed network state information is registered, the client terminal 30 may request the authentication server 10 to provide the changed network state information (S202). In this case, the client terminal 30 providing the identifier of the host terminal 20 to the authentication server 10 may be considered as requesting the provision of the changed network state information.

When the authentication server 10 receives the identifier of the host terminal 20 from the client terminal 30, the authentication server 10 may determine whether the received identifier is the identifier registered with the database (S203). If the identifier received from the host terminal 20 is determined to be the identifier registered with the database, the authentication server 10 may provide the changed network state information mapped into the received identifier to the client terminal 30 (S204). If the identifier received from the host terminal 20 is determined not to be the identifier registered with the database, the authentication server 10 may resend a request for another identifier to the client terminal 30 or complete a network establishment process.

When the client terminal 30 receives the changed network state information, the client terminal 30 may establish a network with the host terminal 20 on the basis of the changed network state information in order to be connected to the host terminal 20 (S205).

In operation S205, the client terminal 30 may receive a password from the user and provide the received password to the host terminal 20 on the basis of the changed network state information. When the host terminal 20 receives the password from the client terminal 30, the host terminal 20 may determine whether the received password is the same as the password stored in operation S104. If the received password is the same as the password stored in operation S104, the host terminal 20 may approve the network connection, and the client terminal 30 may establish a network with the host terminal 20 according to the approval of the network connection. If the received password is different from the password stored in operation S104, the host terminal 20 may request the client terminal 30 to provide another password or complete the network establishment process.

Here, it can be omitted that the host terminal 20 approves the network connection with the client terminal 30, depending on whether the passwords are the same.

In the present invention, the network state information (for example, an IP address, a subnet mask address, a gateway address, an application port, and connectable-network information) is mapped into the identifier of a terminal. Accordingly, it is possible to obtain the network state information about the terminal when providing only the ID of the terminal to the terminal connection application, and to quickly and easily connect terminals with each other on the basis of the obtained network state information.

Also, when the network state information about the terminal is changed, the changed network state information is provided to another terminal. Thus, it is possible to maintain the network connection between the terminals even when the network state information is dynamically changed.

Also, it is possible to store a password for network connection in a database, thereby preventing the password from leaking out and thus further enhancing security.

While the example embodiments of the present invention and their advantages have been described in detail, it should be understood that various changes, substitutions, and alterations may be made herein without departing from the scope of the invention.

What is claimed is:

1. A terminal connection method performed by a first terminal, the terminal connection method comprising:
providing an identifier and network state information of the first terminal to a server; and
upon a request of a second terminal, establishing a network with the second terminal on the basis of the network state information.

2. The terminal connection method of claim 1, further comprising storing a password in the first terminal before or after any one of the operations of claim 1 is performed.

3. The terminal connection method of claim 1, further comprising, when the network state information is changed after providing the identifier and network state information to the server, providing the changed network state information to the server.

4. The terminal connection method of claim 1, wherein the providing of the identifier and the network state information to the server comprises providing as the network state information at least one of an IP address, a subnet mask address, a gateway address, an application port, and connectable connection means to the server.

5. The terminal connection method of claim 2, wherein the establishing of a network with the second terminal comprises:
receiving a password from the second terminal;
determining whether the password received from the second terminal is the same as the stored password; and
if the password received from the second terminal is the same as the stored password, establishing the network with the second terminal.

6. A terminal connection method performed by a first terminal, the terminal connection method comprising:
providing an identifier of the first terminal to a server;
providing network state information of the first terminal to the server; and
upon a request of a second terminal, establishing a network with the second terminal on the basis of the network state information.

7. A terminal connection method performed by a second terminal, the terminal connection method comprising:
providing an identifier of a first terminal to a server;
receiving network state information of the first terminal corresponding to the identifier from the server; and
establishing a network with the first terminal on the basis of the network state information.

8. The terminal connection method of claim 7, wherein the establishing of a network with the first terminal comprises:
providing a password corresponding to the identifier to the first terminal; and
establishing the network with the first terminal on the basis of the network state information according to an approval response to the provision of the password.

9. A terminal connection method performed by a server, the terminal connection method comprising:
receiving an identifier and network state information of a first terminal;
registering the identifier and network state information; and
upon a request of a second terminal, providing the network state information to the second terminal.

10. The terminal connection method of claim 9, further comprising:
receiving changed network state information of the first terminal after registering the identifier and network state information; and
upon a request of the second terminal, providing the changed network state information to the second terminal.

11. The terminal connection method of claim 9, wherein the receiving of the identifier and network state information comprises receiving as the network state information at least one of an IP address, a subnet mask address, a gateway address, an application port, and connectable connection means.

12. The terminal connection method of claim 9, wherein the registering of the identifier and the network state information comprises registering the identifier and the network state information such that the network state information is mapped into the identifier.

13. A terminal connection method performed by a server, the terminal connection method comprising:
receiving an identifier of a first terminal;
receiving network state information of the first terminal;
registering the identifier and the network state information; and
upon a request of a second terminal, providing the network state information to the second terminal.
